(19) United States
(12) Patent Application Publication
(10) Pub. No.: US 2014/0020581 A1
(43) Pub. Date: Jan. 23, 2014

(54) Offset printing tower for a rotary printing press

(71) Applicant: Goss International Corporation, (US)

(72) Inventors: Philippe Lechat, La Chapelle Sur Erdre (FR); Gerard Collet, Vallet (FR)

(73) Assignee: Goss International Corporation, Durham, NH (US)

(21) Appl. No.: 13/871,747

(22) Filed: Apr. 26, 2013

(30) Foreign Application Priority Data
Apr. 27, 2012 (FR) 12 53961

(51) Int. Cl. B41F 13/00

(52) U.S. Cl. CPC B41F 13/0008
USPC 101/216

(57) ABSTRACT

The printing tower consists of a plurality of printing units superposed vertically for the offset printing of a continuous material web, each printing unit including of at least one printing group having a forme cylinder, a transfer cylinder and an inking unit including inking rollers, the printing tower including at least one electronic control module associated with each printing unit for controlling the printing unit, the printing tower including of a first level and a second level each containing at least one printing unit, the first level and the second level being situated one above the other, wherein at least one control module of a printing unit of the second level is disposed on the first level.

The present invention relates to an offset printing tower comprising of several printing units stacked vertically so as to print different colours successively on a continuous material web scrolling through the printing units.

### BACKGROUND

Such a printing tower for example, comprises four printing units superposed vertically for printing four colours, which are usually: yellow, cyan, magenta and black.

Each printing unit consists of at least one printing group comprising a forme cylinder (or plate cylinder), a transfer cylinder (or blanket cylinder), an inking unit having a plurality of inking rollers, of which at least one is motorised.

Each printing unit comprises at least one drive motor for driving the cylinders and the or each motorised inking roller and an electronic drive control module for controlling the or each drive motor.

Each printing unit further comprises group actuators to carry out the functions of a printing group other than the driving of the cylinders and ink rollers in rotation, such as adjusting the dampening of the forme cylinder, regulating and controlling the distribution of ink across the web, the automatic mounting and dismounting of plates on a plate cylinder, and electronic actuator control modules for controlling the group actuators.

The printing units are disposed at a first level and a second level of the printing tower, the first level and the second level being situated one above the other. In order to enable operators to access the various printing units, it is possible to provide the rotary press with fixed foot bridges and/or lifts moving vertically in order to go from one level to another.

### SUMMARY OF THE INVENTION

It is an object of the present invention to provide a printing tower whose operation and maintenance are easy.

The present invention provides a printing tower consisting of several printing units stacked vertically for the offset printing of a continuous material web, each printing unit comprising of at least one printing group having a forme cylinder, a transfer cylinder and an inking unit having inking rollers, the printing tower comprising at least one electronic control module associated with each printing unit for controlling the printing unit, the printing tower comprising a first level and a second level, each containing at least one printing unit, the first level and the second level being situated one above the other, wherein at least one control module for controlling a printing unit of the second level is disposed on the first level.

According to other embodiments, the printing tower includes one or more of the following characteristic features, considered individually or according to any technically possible combinations:
the printing tower includes a drive control module associated with each printing unit for controlling at least one drive motor of the printing unit for driving at least one forme cylinder, at least one transfer cylinder and/or at least one inking roller of the printing unit, the printing tower including at least one drive control module associated with a printing unit of the second level and disposed on the first level;
each drive control module for each printing unit of the second level is disposed on the first level;
each drive control module for each printing unit of the first level is disposed on the first level;
the drive control modules associated with the printing units of the first level are grouped in a first dedicated drive control cabinet disposed on the first level and the drive control modules of the printing units of the second level are grouped in a second dedicated drive control cabinet disposed on the first level;
the printing tower includes an actuator control module associated with a printing unit for controlling at least one group actuator of the printing unit, the printing tower comprising an actuator control module associated with a printing unit of the second level and disposed on the first level;
each actuator control module associated with each printing unit of the second level is disposed on the first level;
each actuator control module of each printing unit of the first level is disposed on the first level;
the actuator control modules associated with the printing units of the first level are grouped together in a first dedicated actuator cabinet located on the first level and the actuator control modules of the printing units of the second level are grouped together in a second dedicated actuator cabinet on the first level;
the drive control modules arranged on the first level are arranged on a first lateral face of the printing tower and the actuator control modules arranged on the first level are arranged on a second opposing lateral face;
the first level is situated below the second level;
the printing tower comprises two printing units on the first level and two printing units on the second level;
the printing tower consists of a first tower member and a second tower member that are stacked, each one comprising of at least one printing unit, and respectively defining the first level and the second level of the printing tower.
The invention also relates to a rotary printing press comprising at least one printing tower as defined above.

### BRIEF DESCRIPTION OF THE DRAWINGS

The invention and its advantages will be better understood upon reading the description which follows, given by way of example and with reference made to the accompanying drawings, in which:

FIG. 1 is a schematic side view in cross section of a printing tower for a rotating press; and

FIGS. 2 and 3 are schematic side views and elevation drawings of the printing tower of FIG. 1, illustrating the two opposite sides of the printing tower.

### DETAILED DESCRIPTION

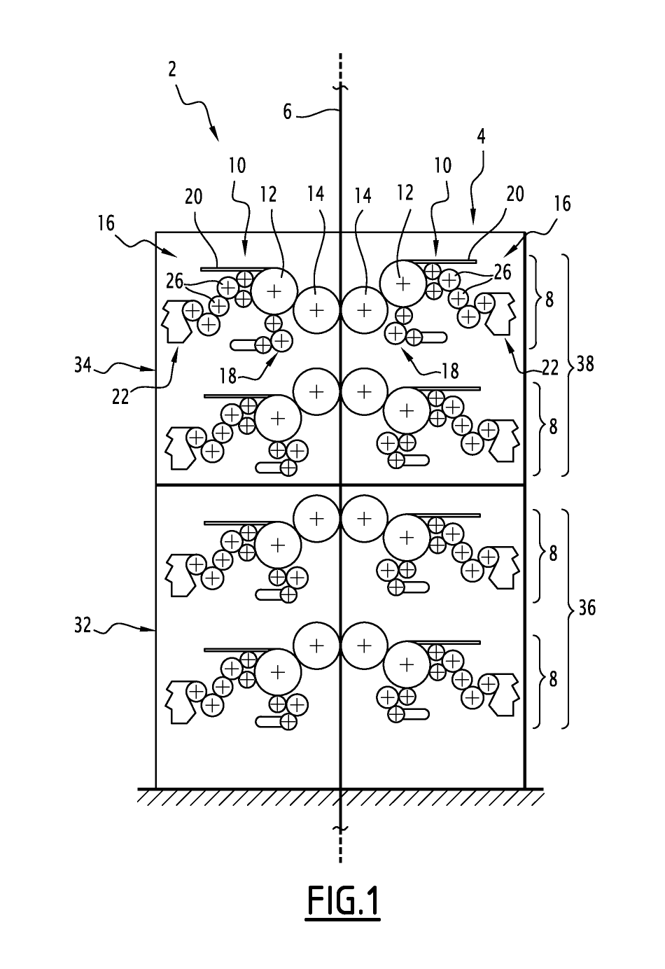

As shown in FIG. 1, the rotary offset press 2 comprises a printing tower 4 for offset printing of a continuous web 6, in particular a paper web.

The rotary printing press 2 conventionally comprises a plurality of printing towers, each one for the printing of a respective web, a web unwinding device associated with each printing tower 4 for unwinding the web from a 6 roller, and a combination assembly for combining webs printed by the different printing towers 4 making it possible to ensure the gathering, folding and the longitudinal and/or transverse cutting of the webs and/or the assembling of webs by stapling or stitching and/or gluing, in order to provide an output of notebooks or signatures.

Only one single printing tower 4 is shown in FIGS. 1 to 3 and described here below.

In FIG. 1, the printing tower 4 consists of printing units 8. Each printing unit 8 comprises at least one printing group 10 for printing one surface of the web 6.

Each printing group 10 comprises of a forme cylinder 12, a transfer cylinder 14, an inking unit 16, a dampening unit 18, and a plate change unit 20.

The forme cylinder 12 carries on its periphery the formes to be the printed. The forme cylinder 12 is for example a plate cylinder designed to enable the detachable fastening of flexible plates (not shown) carrying the formes to be printed. The plates are changed depending upon the production processes to be carried out. Preferably, such a forme cylinder 12 carries several plates arranged axially side by side along the axis of the cylinder, and one or more plates arranged in turn, one behind the other around the circumference of the forme cylinder 12. The number of plates arranged axially side by side is for example between 4 and 6, and the number of plates in turn is for example, between 1 and 2. The forme cylinder 12 is for example of the type 4×1, 4×2, 5×2 or 6×2.

The transfer cylinder 14 is arranged so as to be pressed against the forme cylinder 12, and transferring ink from the forme cylinder 12 onto the web 6. The transfer cylinder 14 here is a blanket cylinder designed to receive over its periphery a blanket (not shown).

The axes of the forme cylinder 12 and the transfer cylinder 14 are parallel.

In the example illustrated, the printing tower 4 includes four recto/verso printing units 8 with four cylinders in the “blanket-to-blanket” configuration. Each printing unit comprises two printing groups 10, of which the transfer cylinders 14 are arranged in a manner so as to come to be pressed against one another while squeezing the web. Each transfer cylinder 14 defines a printing cylinder for the other. Each printing unit 8 is set up to print one respective colour on the web 6. The colours used usually are: black, cyan, magenta and yellow.

Each inking unit 16 includes an ink source 22 and an inking roller assembly 26 for transferring the ink from the ink source to the forme cylinder 12. The ink source 22, for example, consists of an ink fountain and an ink fountain roller powered by a dedicated motor.

Each dampening unit 18 is configured so as to apply the dampening liquid, usually water, on the forme cylinder 12. The dampening unit is optional and may be omitted in order to carry out waterless offset printing (or “waterless printing” in English).

Each plate change unit 20 is designed for the automatic unloading of plates from the forme cylinder 12 and the automatic loading of new plates onto the forme cylinder 12. The plate change unit 20 is optional, as a variant the plate change may be carried out manually.

As illustrated in FIGS. 1 to 3, the printing tower 4 comprises a first level 36 having at least one printing unit 8 and a second level 38 having at least one printing unit 8. Each level here includes two printing units 8.

The printing tower 4 is composed of a first tower member 32 and a second tower member 34 stacked one on top of the other, each comprising at least one printing unit 8 and respectively defining the first level 36 and the second level 38 of the printing tower 4.

Each printing unit 8 comprises of at least one drive motor for driving in rotation at least one forme cylinder 12, at least one transfer cylinder 14 and/or at least one inking roller 26 of the printing unit 8.

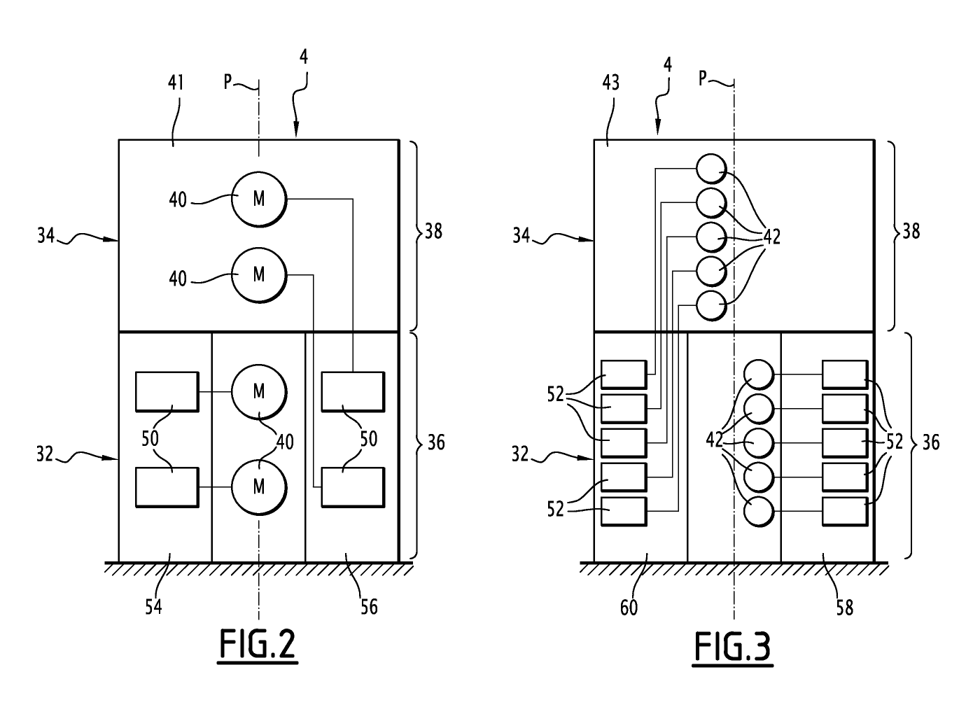

The drive motors 40 are disposed on a first lateral face 41 of the printing tower 4 (FIG. 2).

In the example illustrated, each printing unit 8 includes one single drive motor 40 per printing unit 8, coupled with the forme cylinders 12, with the transfer cylinders 14 and with the motorised inking rollers 26, of the two printing groups 10 of the printing unit 8.

Each printing unit 8 further comprises group actuators 42 for execution of various functions other than the driving of cylinders and inking rollers of each printing group 10. The group actuators 42 may include, without limitation:

adjustment of the position of an ink fountain roller;

driving the rotation of an ink fountain roller; and

adjustment of the ink distribution across the web width, for example by way of ink keys;

adjustment of the dampening;

automatic plate changing;

throwing on/throwing off of the transfer cylinders of the printing unit;

washing of the blanket.

In FIG. 3, for the purposes of simplification, the group actuators 42 are shown arranged on a second lateral face 43 of the printing tower 4, opposite to the first lateral face, according to a linear arrangement. Quite understandably, in practice they are presented in a different arrangement. Certain group actuators 42 may also be accommodated within the printing tower 4.

The printing tower 4 includes four electronic control modules for controlling the motors 40 and/or the group actuators 42.

The control modules include drive control modules 50 for controlling the drive motors 40 and actuator control modules 52 for controlling the group actuators 42.

The control modules are disposed on the lateral faces 41, 43 of the printer tower 4 in order to facilitate easy access thereto. The drive control modules 50 are disposed on the first lateral face 41, on the same side as the drive motors 40. The actuator control modules 52 are disposed on the second lateral face 43.

At least one control module for a printing unit 8 of the second level 38 is disposed on the first level 36.

As illustrated, all of the drive control modules 50 of the printing units 8 of the second level 38 are disposed on the first level 36 (FIG. 2). All of the actuator control modules 52 of the printing units 8 of the second level 38 are disposed on the first level 36. Thus, the control modules are all accessible on the first level 36, which facilitates access thereto for operational and maintenance activities.

At least one control module of a printing unit 8 of the second level 38 is disposed on the first level 36.

Advantageously, as illustrated, the first level is the lower level and the second level is the upper level, located above the first level. The control units are thus grouped on the lower level (first level), which allows operators to access them without having to go up to the upper level (second level), by means of using fixed foot bridges or lifts moving vertically.

The configuration could most certainly be reversed, with the first level being the upper level and the second level being the lower level. The control modules of the lower level would thus be disposed on the upper level and grouped together with the control modules of the upper level.

As illustrated in FIG. 2, the drive control modules 50 of the first level 36 are grouped together on the first level in a first drive control cabinet 54, and the drive control modules 50 of the second level 38 are grouped together on the first level in a second drive control cabinet 56. The first drive control cabinet 54 and the second drive control cabinet 56 are separated. They are disposed respectively on each side of a median transverse plane of the printing tower 4.

As illustrated in FIG. 3, the actuator control modules 52 of the first level 36 are grouped together on the first level in a first actuator control cabinet 58 and the actuator control modules 52 of the second level 38 are grouped together on the first level in a second actuator control cabinet 60. The first actuator control cabinet 58 and the second actuator control cabinet 60 are separated. They are disposed respectively on each side of a median transverse plane of the printing tower 4.

Thus, each level has dedicated cabinets, which facilitates the operational and maintenance activities.

By way of a variant, the control modules of the first level and the second level are arranged in one or more common cabinet(s) each one containing the control modules of the first level and the control modules of the second level.

In a particular embodiment, the drive control modules 50 of the or each printing unit 8 of the first level 36 and of the or each printing unit 8 of the second level 38 are arranged in a same cabinet on the first level 36 and/or the actuator control modules 52 of the or each printing unit 8 of the first level 36 and of the or each printing unit 8 of the second level 38 are arranged in a same cabinet.

When the printing tower 4 is composed of a first tower member 32 and a second tower member 34 that are stacked, each drive—or actuation control module of a printing unit 8 of the second tower member 32 that is disposed on the first level 36, is disposed on the first tower member 32.

Thanks to the invention, the printing tower is compact while at the same time also enabling easy operation and maintenance thereof. Maintenance or control of the drive motors and/or group actuators can easily be done from one same level.

The invention is not limited to a printing tower with four recto/verso printing units superposed in a blanket to blanket configuration with four cylinders.

The printing tower may comprise of several superposed printing units, in recto configuration, in blanket to blanket recto/verso configuration, or in satellite configuration, recto or recto/verso, with five, seven or nine cylinders.

What is claimed is:

1-15. (canceled)

16. A printing tower comprising:
a plurality of printing units superposed vertically for the offset printing of a continuous material web, each printing unit comprising at least one printing group having a forme cylinder, a transfer cylinder and an inking unit including inking rollers;
at least one electronic control module associated with each printing unit for controlling the printing unit, the printing tower including a first level and a second level each containing at least one of the printing units, the first level and the second level being situated one above the other, wherein at least one of the at least one electronic control module of the at least one printing unit of the second level is disposed on the first level.

17. The printing tower as recited in claim 16 wherein the electronic control modules include at least one drive control module associated with each printing unit for controlling at least one drive motor of the printing unit for driving at least one forme cylinder, at least one transfer cylinder and/or at least one inking roller of the printing unit, the printing tower including at least one of the at least one drive control module associated with the at least one printing unit of the second level and disposed on the first level.

18. The printing tower as recited in claim 17 wherein each drive control module for each printing unit of the second level is disposed on the first level.

19. The printing tower as recited in claim 17 wherein each drive control module for each printing unit of the first level is disposed on the first level.

20. The printing tower as recited in claim 19 wherein the drive control modules associated with the printing units of the first level are grouped in a first dedicated drive control cabinet disposed on the first level and the drive control modules of the printing units of the second level are grouped in a second dedicated drive control cabinet disposed on the first level.

21. The printing tower as recited in claim 17 wherein the drive control modules arranged on the first level are arranged on a first lateral face of the printing tower and the actuator control modules arranged on the first level are arranged on a second opposing lateral face.

22. The printing tower as recited in claim 16 wherein the electronic control modules include at least one actuator control module associated with at least one of printing units for controlling at least one group actuator of the at least one printing unit, the printing tower comprising at least one of the at least one actuator control module associated with at least one of the at least one printing unit of the second level and disposed on the first level.

23. The printing tower as recited in claim 22 wherein each actuator control module associated with each printing unit of the second level is disposed on the first level.

24. The printing tower as recited in claim 22 wherein each actuator control module of each printing unit of the first level is disposed on the first level.

25. The printing tower as recited in claim 24 wherein the actuator control modules associated with the printing units of the first level are grouped together in a first dedicated actuator cabinet located on the first level and the actuator control modules of the printing units of the second level are grouped together in a second dedicated actuator cabinet on the first level.

26. The printing tower as recited in claim 16 wherein each control module of each printing unit of the first level is arranged on the first level.

27. The printing tower as recited in claim 16 wherein the first level is situated below the second level.

28. The printing tower as recited in claim 16 wherein two of the printing units are on the first level and two printing units are on the second level.

29. The printing tower as recited in claim 16 wherein the first level is defined by a first tower member and the second level is defined by a second tower member, the first tower member and the second tower member being stacked, each of the first tower member and the second tower member comprising at least one of the printing units.

30. A rotary printing press comprising at least one of the printing tower recited in claim 16.
